(19) United States
(12) Patent Application Publication
(10) Pub. No.: US 2026/0042313 A1
(43) Pub. Date: Feb. 12, 2026

(54) Environmentally Friendly Cork Shaving Tool

(71) Applicant: Xochitl Acosta Brent, Redwood City, CA (US)

(72) Inventor: Xochitl Acosta Brent, Redwood City, CA (US)

(73) Assignee: Xochitl Acosta Brent, Redwood City, CA (US)

(21) Appl. No.: 18/796,103

(22) Filed: Aug. 6, 2024

(51) Int. Cl. B26B 21/22

(52) U.S. Cl. CPC B26B 21/225

(57) ABSTRACT

An environmentally friendly cork shaving tool for reusing corks to reseal partially consumed bottles. The tool includes a screw top cap enclosure with guide hole, a side hinged lid, internal shaving blade and storage chamber. When the user twists the cork, in a clockwise manner, a shaving action can take place, which allows shavings to migrate into the chamber and resizes the cork for reinsertion into the bottle. The side hinged lid allows for easy emptying of the accumulated shavings in the storage chamber. The captured shavings can be reused for composting or crafts. The tool's tactile operation allows the user a sensation of creating a useful by-product of the cork.

Background of the invention This invention relates generally to the field of handheld shaving tools and more specifically to a shaving tool for assisting in reusing corks to facilitate storage. When opening a bottle that has a cork stopper, people are often left with beverage that is not entirely consumed. If not stored properly, the beverage can go bad within a few days because the cork that came with the bottle or container may not fit back into the opening. A pre-purchased cork stopper may not always be available. To solve this problem, it is an object of the present invention to shave one end of the cork by using the environmentally friendly cork shaving tool. Another object of the invention is to reuse the shavings by composting them or in craft projects.

Brief Summary of the invention. It is an object of the present invention to provide a shaving tool that can reuse corks to facilitate storage of beverages in their original container.

It is another object of the invention to trap shavings within the chamber of the tool for future use.

Another object of the invention is to provide an easy way to have access to the enclosed chamber, such as a screw top, that can easily be unscrewed to empty the accumulated shavings.

Brief description of the several views of the drawings Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

FIG. 1 Shows the tool with the screw top side hinge safety lid open, showing the guide hole and an empty lower chamber.

FIG. 2 Shows an exploded view of the internal shaving blade attached to the screw top cap.

FIG. 3 Shows an exploded view of the screw top safety lid in the opened position, showing the guide hole.

The drawings constitute a part of this specification and include exemplary embodiments to the invention, which may be embodied in various forms. It is to be understood that in some instances various aspects of the invention may be shown exaggerated or enlarged to facilitate an understanding of the invention. The shaving tool 100 may be made of metal, plastic, silicone, or the like. In additional embodiments, the tool may have at least one electric motor and plurality of cutting blades configured to remove material from the cork surface.

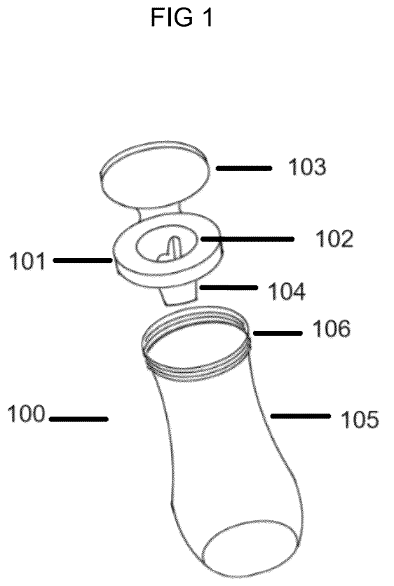

Referring now to FIG. 1 As demonstrated, shows a shaving tool 100, according to the embodiment of the present disclosure. As illustrated, the shaving tool 100 may include a cylindrical chamber 105, with a top section 106 designed for securing the screw top cap 101, containing a guide hole 102, with side hinged safety lid 103 and internal shaving blade 104.

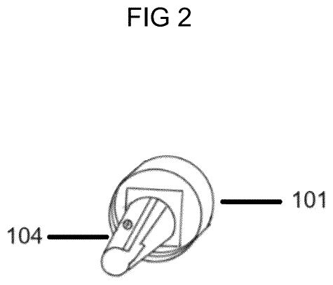

Referring now to FIG. 2 we see an exploded view of the internal shaving blade 104 attached to the screw top cap 101. By twisting the cork, in a clockwise manner, against the shaving blade 104, a shaving action can take place.

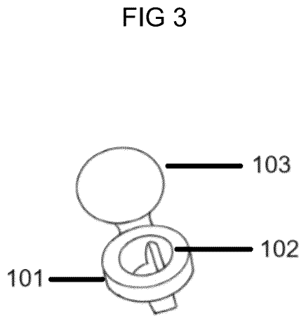

Referring now to FIG. 3 we see an exploded view of the screw top cap 101 with the safety lid 103 in the open position, showing the guide hole 102. By inserting the cork into the guide hole 102, a user can initiate the task of shaving

Detailed Description of the invention Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of components or elements may be exaggerated for clarity.

The shaving tool is intended to be a handheld item and includes a main body compromised of a screw top enclosure with a guide hole, a side hinged safety lid, internal shaving blade and storage chamber. When the user twists the cork in a clockwise manner against the blade a shaving action can take place.

The portable cork shaving tool enables reuse of corks for resealing partially consumed bottles, further, the accumulated shavings can later be reused for composting or crafts. The tool facilitates sustainable enjoyment of wine and champagne or other beverages.

1. A portable cork shaving tool, comprising: a housing having a storage chamber for capturing cork shavings; a hinged lid coupled to the housing and movable between an open position for emptying the cork shavings from the storage chamber and a closed position; an angled shaving blade disposed within the storage chamber; a screw top removably secured to the housing for securing the angled shaving blade within the storage chamber; and a top cover coupled to the housing for enclosing the angled shaving blade when the screw top is removed, thereby providing safety.
